(19) United States
(12) Patent Application Publication
(10) Pub. No.: US 2020/0368980 A1
(43) Pub. Date: Nov. 26, 2020

(54) IMPROVEMENTS TO TIRE REPAIR APPARATUS

(71) Applicant: TRYDEL RESEARCH PTY LTD, Victoria (AU)

(72) Inventor: Terence Dowel, Victoria (AU)

(21) Appl. No.: 16/635,865

(22) PCT Filed: Aug. 3, 2018
(86) PCT No.: PCT/AU2018/050812

§ 371 Date: Jan. 31, 2020

(30) Foreign Application Priority Data
Aug. 3, 2017 (AU) 2017903070

(51) Int. Cl. B29C 73/16; B29C 73/02; B60C 29/06; F16K 15/02; B05B 12/08

(52) U.S. Cl. CPC B29C 73/166; B29C 73/025; B05B 12/087; F16K 15/026; B60C 29/062

(57) ABSTRACT

An outlet coupling for a sealant container comprises a connector having an open first end to engage with a tire valve stem and an open second end continuous with a channel. The outlet coupling also comprises a pin at least partially located within the channel, the pin comprising a body having a head and an engaging portion at substantially opposite ends thereof. The head is in contact with a biasing member and the engaging portion is engaged with a sealing element. The pin is movable between an open position wherein the sealing element is spaced from an end of the channel and a closed position wherein the sealing element seals the end of the channel. Methods of sealing a puncture in an inflatable article, such as a pneumatic tire, with a tire repair apparatus using the outlet coupling are also disclosed.

### FIELD OF THE INVENTION

This invention relates to an apparatus and methods for the repair of tires following a puncturing incident. More particularly, the present invention relates to an improved valve for an outlet coupling for controlling the dispensing of a sealant composition from a sealant container into a tire following a puncturing incident and to a safety pressure release system for such sealant containers.

### BACKGROUND OF THE INVENTION

Any reference to background art herein is not to be construed as an admission that such art constitutes common general knowledge in Australia or elsewhere.

Sealant formulations for pneumatic tires have been developed to provide temporary sealing after a puncturing incident has occurred or the tire is otherwise flat. The sealing of punctured tires with such formulations is a stop gap measure in that it serves the purpose of making the vehicle with the punctured tire drivable again, at a limited speed, for a limited period of time and/or over a limited distance. After that the tire is either to be replaced or, if possible, repaired.

Tire puncture repair kits were developed to conveniently deliver such sealant formulations and restore vehicle mobility following a puncture event, thereby eliminating the need to carry a spare wheel and associated equipment. This afforded a quicker, easier and safer means of restoring vehicle mobility as well as saving weight. Such a kit is described in the present applicant's earlier international application number PCT/AU2017/050126, which is hereby incorporated by reference in its entirety.

Tire puncture repair kits may include a plugin compressor which connects to a container of latex-based sealant that can be pumped into the tire using the generated pressure. These kits generally have a valve in their outlet coupling, which attaches to the tire valve stem. The valve prevents the inadvertent release of the sealant if the connector is not connected to the tire valve stem. This check valve is often formed from a number of individual components which may each be seated on O-rings or the like in an attempt to minimise leakage.

Further, the container of sealant may be placed under significant pressure during the dispensing operation. Different kits may provide for compressors which generate different top end pressures which can be a challenge in terms of providing for an after-market universal sealant container. This is particularly so if such a container is designed to be formed from a lightweight material. Such a sealant container is described in the present applicant's earlier Australian patent application number AU2016905062, which is hereby incorporated by reference in its entirety. There is a risk that containers of this kind, which may be made from a suitable plastic such as PET, may suffer from a blow out if the pressure within becomes too high.

It would be desirable to provide for a tire repair apparatus which includes a simple and robust valve on the sealant container outlet connector to minimise sealant leakage and/or provides for a pressure release system as part of the sealant container or at least offers a commercial alternative over those in the prior art.

### SUMMARY OF THE INVENTION

In a first broad form, but not necessarily the broadest form, the present invention relates to an outlet coupling for a sealant container comprising:
(a) a connector having an open first end, to engage with a tire valve stem, and an open second end continuous with a channel; and
(b) a pin at least partially located within the channel, the pin comprising a body having a head and an engaging portion at substantially opposite ends thereof, the head in contact with a biasing member and the engaging portion engaged with a sealing element;

wherein, the pin is movable between an open position wherein the sealing element is spaced from an end of the channel and a closed position wherein the sealing element seals the end of the channel.

In one embodiment, the connector comprises a cavity located between the open first and second ends and continuous with both.

Suitably, an inner surface of the cavity is adapted to engage with a tire valve core spigot of the tire valve stem.

In preferred embodiments, the inner surface of the cavity is threaded to engage with the tire valve stem, although an interference fit, click-on, snap-lock or bayonet mechanism or other engagement means are within the scope of this invention so long as they are compatible with the tire valve stem. A screw-threaded engagement is highly preferred as the vast majority of tire valve stems are designed for such an engagement.

Suitably, the pin head extends into or is immediately adjacent the inner surface of the cavity adapted to engage with the tire valve core spigot.

Preferably, the pin head extends into the inner surface of the cavity adapted to engage with the tire valve core spigot.

Suitably, the biasing member is a spring which contacts an underside of the pin head.

In certain embodiments, the spring is located between the underside of the pin head and a biasing surface.

The biasing surface may be an upper extent of a channel piece.

The channel piece may define the channel within its interior.

In some embodiments, the sealing element is a bung and in the closed position it will be appreciated that the bung abuts an end of the channel piece.

The bung will abut an end of the channel piece substantially opposite to the end of the outlet coupling having the connector open first end.

In some embodiments, the sealing element is an O-ring engagingly received at least partially within an annular recess in the engaging portion of the pin.

Suitably, a lower extent of the channel comprises an outwardly flared inner wall such that in the closed position the O-ring abuts the flared inner wall thus sealing the channel to fluid flow.

An outer surface of the channel piece may have gripping features which improve the grip of a sealant hose onto the outer surface. Such features may include a hose barb fitting, ribs, lips, scoring, a roughened surface and like features as will be known in the art.

In embodiments, the outlet coupling further comprises an outer housing within which the connector is at least partially located.

The channel piece may also be located, at least partially, within the outer housing.

Suitably, the biasing surface of the channel piece is adjacent an underside of the connector.

Suitably, the connector is fastened within the outer housing. The fastening may be screw-threaded, an interference fit, male-female connection or other inter-locking means.

The outer housing may have a housing cavity within which an upper extent of the channel piece is located.

Suitably, the outer housing comprises an opening through which the channel piece passes.

Preferably, the channel piece forms a sealing engagement with the opening of the outer housing through which it passes. The sealing engagement may be assisted by an O-ring or like sealing or fastening member, which may be accommodated within a recess in a housing flange of the outer housing.

Suitably, the engaging portion of the pin extends beyond the end of the channel piece to be at least partially accommodated within the bung.

The engaging portion of the pin may be engaged within the bung by a screw-threaded or press fit connection.

In preferred embodiments, the outlet coupling does not comprise any metal parts.

Suitably, all components of the outlet coupling are made from one or more of a polymer, a plastic or a composite material. Preferably, the components of the outlet coupling are made from a glass-filled polymer such as, but not limited to, a glass-filled nylon.

In an aspect of the first broad form, the invention provides for a method of sealing a puncture in a pneumatic tire including the steps of:

(a) providing a tire repair apparatus comprising a sealant container containing a sealant formulation, the sealant container having an outlet hose extending therefrom and the outlet hose provided with an outlet coupling, wherein the outlet coupling comprises;
i. a connector having an open first end, to engage with a tire valve stem, and an open second end continuous with a channel;
ii. a pin at least partially located within the channel, the pin comprising a body having a head and an engaging portion at substantially opposite ends thereof, the head in contact with a biasing member and the engaging portion engaged with a bung;
iii. wherein, the pin is movable between an open position wherein the bung is spaced from an end of the channel and a closed position wherein the bung abuts the end of the channel;

(b) connecting the open first end of the connector to a valve stem of the pneumatic tire such that the pin engages with a valve core spigot of the valve stem to force the pin into the open position;

(c) providing a fluid pressure within the container;

to thereby discharge the sealant formulation from the sealant container into an internal chamber of the pneumatic tire and seal the puncture.

A second broad form of the present invention relates to a pressure release system for a sealant container comprising:
(a) a sealant container comprising a base having an aperture formed therethrough; and
(b) a pressure release device comprising a sealing face having a sealing spigot extending therefrom;

wherein, the sealing spigot of the pressure release device is located within the aperture.

In one embodiment, the sealing spigot of the pressure release device forms a sealing engagement within the aperture. In such an embodiment, the sealing spigot of the pressure release device may form an interference fit within the aperture.

In an alternative embodiment, the pressure release system may further comprise a deflection baffle which engages with the aperture.

In this alternative embodiment, the deflection baffle engages with the aperture and the sealing spigot of the pressure release device is accommodated within the deflection baffle.

Suitably, the deflection baffle has at least one channel within which the sealing spigot of the pressure release device is at least partly accommodated.

Suitably, the at least one channel extends through the deflection baffle such that a continuous flow path is provided.

Preferably, the at least one channel is a central channel which is intersected by at least one additional channel.

Suitably, the at least one additional channel intersects the central channel at an angle less than 90 degrees, preferably less than 70 degrees, even more preferably less than 60 degrees.

In certain embodiments, the deflection baffle engages with the aperture by an interference fit but preferably the aperture is provided with a screw-threaded surface which engages with a screw-threaded portion on the deflection baffle.

Suitably, the pressure release device further comprises an elongate body.

Preferably, the pressure release device comprises at least one chamfered face to engage with the sealant container.

Preferably, the pressure release device is a bar with a chamfered face at either end thereof.

Suitably, the sealing spigot may have at least one inclined face at an end thereof furthest from the sealing face of the pressure release device.

In embodiments of either broad form, the sealant container may comprise a body substantially made from PET (polyethylene terephthalate) and which comprises a body and a neck with an integrally formed inlet extending from the neck.

Particularly, although the present invention is not limited thereto, the sealant container may comprise:
(a) a body, a base and a neck, the container substantially made from PET;
(b) one of the neck or the base having an integrally formed inlet extending therefrom; and
(c) an outlet hose extending from an opening of the neck;

wherein, the neck or base inlet comprises a valve or plug within an internal channel thereof.

Preferably, it is the neck which has an integrally formed neck inlet.

In one embodiment, the container is made from at least 90%, preferably at least 95%, more preferably at least 98%, more preferably still at least 99% PET. The PET may be recycled PET.

Suitably, the neck inlet is a tubular extension or spigot integrally formed with the neck.

In one embodiment, the neck inlet extends at substantially a right angle to the neck.

The internal channel of the neck inlet has a first opening which is continuous with the interior of the sealant container.

The internal channel of the neck inlet has a second opening at an end of the neck inlet opposite that which is adjacent the neck of the sealant container.

In one embodiment, the neck inlet internal channel is a threaded channel.

The opening of the neck inlet of the container is formed at an end of the neck opposite that which is adjacent the body of the sealant container.

The outlet hose is connected to the opening of the neck to form a sealing engagement.

The outlet hose may extend away from the container vertically at substantially a right angle when the container is arranged with the neck inlet extending substantially horizontally from the neck.

The internal passage of the outlet hose is continuous with the interior of the sealant container.

Suitably, the outlet coupling of the first broad form is located on an end of the outlet hose.

The channel piece of the outlet coupling may be located within the end of the outlet hose furthest from the sealant container.

Suitably, the base inlet, when present, may take any form as described for the neck inlet.

The base inlet may extend from the base to be substantially parallel with respect to an axis passing vertically through the length of the container body and through the centre of the opening of the neck.

In one embodiment, the sealant container may be substantially metal-free.

In an aspect of the second broad form, the invention provides for a method of sealing a puncture in a pneumatic tire including the steps of:

(a) providing a tire repair apparatus comprising a sealant container containing a sealant formulation, the sealant container comprising;
i. an outlet hose extending therefrom;
ii. a base having an aperture formed therethrough;
iii. a pressure release device located within the sealant container and comprising a sealing face having a sealing spigot extending therefrom, the sealing spigot located within the aperture;

(b) connecting the outlet hose to a valve stem of the pneumatic tire;

(c) providing a fluid pressure within the sealant container;

to thereby discharge the sealant formulation from the sealant container into an internal chamber of the pneumatic tire and seal the puncture.

The various features and embodiments of the present invention, referred to in individual sections which follow apply, as appropriate, to other sections, mutatis mutandis. Consequently features specified in one section may be combined with features specified in other sections as appropriate.

Further features and advantages of the present invention will become apparent from the following detailed description.

### BRIEF DESCRIPTION OF THE DRAWINGS

In order that the invention may be readily understood and put into practical effect, preferred embodiments will now be described by way of example with reference to the accompanying figures wherein:

FIG. 1A is an elevation view of one embodiment of an outlet coupling;

FIG. 1B is a perspective view of the outlet coupling of FIG. 1A;

FIG. 1C is a sectional view of the outlet coupling of FIG. 1A;

FIGS. 2A and 2B are an elevation view and a sectional view, respectively, of an outer housing for an outlet coupling;

FIGS. 2C and 2D are an elevation view and a sectional view, respectively, of a connector for an outlet coupling;

FIGS. 2E and 2F are a perspective view and a sectional view, respectively, of a channel piece for an outlet coupling;

FIG. 3A is a perspective view of a pin for an outlet coupling;

FIGS. 3B and 3C are an elevation view and a sectional view, respectively, of a bung for an outlet coupling;

FIGS. 4A and 4B are perspective views of an outlet coupling engaging with a valve stem with FIG. 4A showing the partially engaged position and FIG. 4B showing the fully engaged position;

FIG. 5 is a perspective view of one embodiment of a tire repair apparatus with the outlet coupling of FIG. 1A;

FIG. 6A-6C are a perspective view, side elevation view and sectional view, respectively, of a pressure release device;

FIG. 7 is a perspective view of a sealant container fitted with the pressure release device of FIG. 6A-C to form a pressure release system;

FIGS. 8A and 8B are an elevation view and a sectional view, respectively, of a deflection baffle for a pressure release system;

FIG. 9A is a perspective view of one embodiment of a sealant container with the deflection baffle of FIGS. 8A and 8B about to be located in the threaded aperture;

FIG. 9B is a perspective view of the sealant container of FIG. 9A with the pressure release device of FIG. 6A-6C engaged with the deflection baffle of FIGS. 8A and 8B to form a pressure release system;

FIG. 10 is an elevation view of another embodiment of an outlet coupling;

FIG. 11 is a sectional view along line C-C of the outlet coupling of FIG. 10;

FIG. 12 is an image of the outlet coupling of FIG. 10 separated into its components; and

FIG. 13 is an image showing the outlet coupling of FIG. 10 engaging with a valve stem position in a fully engaged position.

### DETAILED DESCRIPTION OF THE INVENTION

Unless defined otherwise, all technical and scientific terms used herein have the same meaning as would be commonly understood by those of ordinary skill in the art to which this invention belongs.

While the discussion herein largely relates to the use of the present tire repair apparatus in the repair of large vehicle pneumatic tires, such as cars, vans and trucks, it will be appreciated that the invention is not so limited. Particularly, the present apparatus may find use in the repair of bicycle tires or indeed any inflatable tire having a valve stem for the input of sealant formulation and air.

Embodiments of the invention will now be described by reference to the following figures whereby like numerals refer to like parts. It will be appreciated that the invention is not limited by the embodiments shown but rather these are merely exemplary to assist in understanding of the invention.

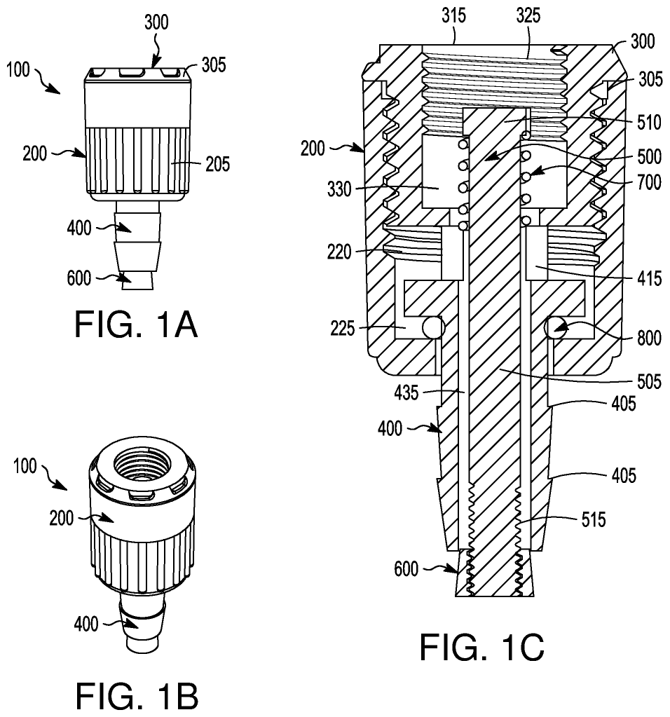

FIGS. 1A-C best represent the outlet coupling 100 which, in the embodiment shown, comprises an outer housing 200, a connector 300, a channel piece 400, a pin 500, a sealing element in the form of a bung 600, a biasing member 700 and a sealing member 800.

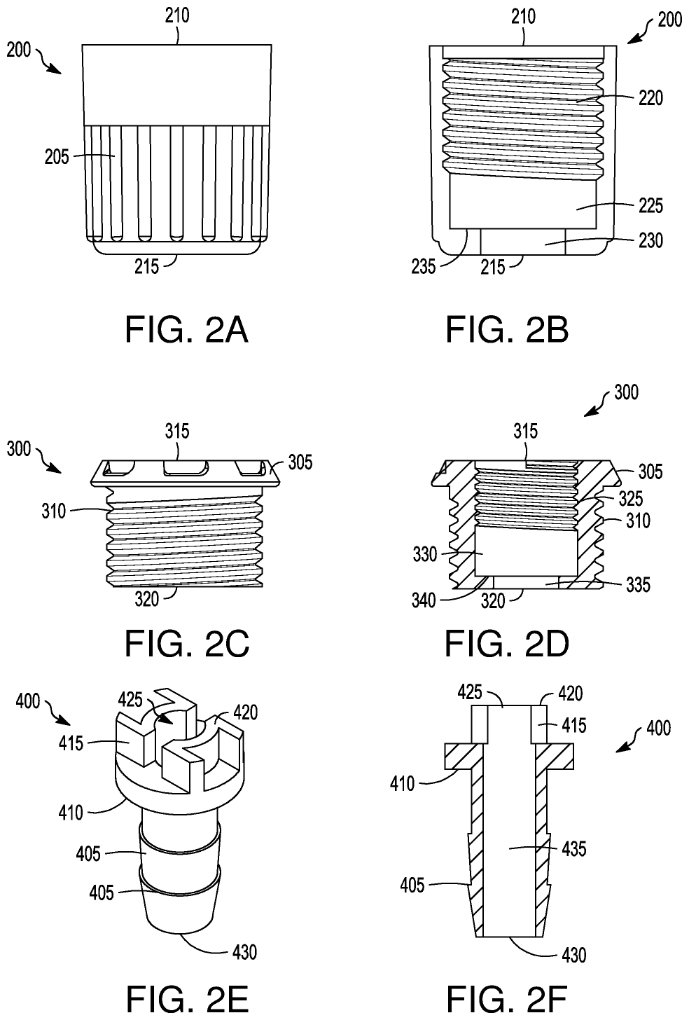

FIGS. 2A and 2B show further detail of the outer housing 200. It will be appreciated that, in certain embodiments, the outer housing 200 may not be necessary. It serves as an effective and convenient means for containing, connecting and holding in appropriate relative positions the various components of the outlet coupling 100 but it will be clear that this could be achieved in other ways. The outer housing 200 may be provided with a ribbed section 205 on its external surface to allow for easier grip when manipulating the outlet coupling 100. It will be appreciated that other designs or raised features could likewise be used to improve grip such as a hose barb fitting. The outer housing 200 is provided with a housing open first end 210 and a housing open second end 215. As indicated in FIG. 2B, the housing open second end 215 is of a smaller diameter or area than the housing open first end 210. Adjacent the housing open first end 210 is a housing threaded portion 220 which also, in part, forms a housing cavity 225 which is continuous with the housing open first and second ends 210 and 215, respectively. The constriction of the housing cavity 225 at a lower extent thereof to form the housing open second end 215 results in a housing flange 235 being formed.

FIGS. 2C and 2D show further detail of the connector 300 which comprises a lip 305 and a connector outer threaded portion 310. The connector 300 presents a connector open first end 315 and a connector open second end 320. As best seen in FIG. 2D, the connector open second end 320 is of a smaller diameter or area than the connector open first end 315. Similar to the outer housing 200, the connector 300 further comprises a connector inner threaded portion 325 adjacent the connector open first end 315 and which, in part, defines a connector cavity 330 which is continuous with the connector open first end 315 and the connector open second end 320. The constriction of the connector cavity 225 at a lower extent thereof to form the connector open second end 320 results in a connector flange 340 being formed.

It can be seen from FIG. 1C that, in use, the connector 300 is located within the housing cavity 225 of the outer housing 200. The connector outer threaded portion 310 engages with the housing threaded portion 220 and the connector 300 is screwed into place until the lip 305 abuts the upper extent of the outer housing 200. It will be appreciated that the connector 300 could be accommodated and held in place within the outer housing 200 by a range of means and locking mechanisms such as are known in the art and including an interference fit, snap lock, bayonet and the like.

FIGS. 2E and 2F represent the channel piece 400 which can be seen to have outer ribs 405 suited to gripping a hose outlet from a sealant container. It will be understood that a range of shapes and features may be used to resist slipping of such a hose away from the lower extent of the channel piece 400 with the outer ribs 400 simply representing a convenient means of doing so. A channel flange 410 is formed by a widening towards an upper extent of the channel piece 400 creating a head section. The upper surface of this head section is provided with one or more raised portions 415 which form, on an upper surface thereof, a biasing surface 420. The channel piece 400 defines a channel 435 within its interior which is continuous with a channel open first end 425 and a channel open second end 430. The raised portions 415 further define the channel vertically above the head section of the channel piece 400.

As best seen in FIG. 1C, the channel piece 400 sits partly within the housing cavity 225 with the biasing surface 420 immediately adjacent the underside of the connector 300 and the connector open second end 320. The channel piece 400 passes through the housing open second end 215 such that the outer ribs 405 are exposed for connection of an outlet hose. To provide a sealing engagement, a sealing member 800, which in the embodiment shown is in the form of an O-ring 800, is located between the housing flange 235 and the channel flange 410 to prevent leakage of any sealant which may enter the housing cavity 225.

The outer housing 200, connector 300 and channel piece 400 may be constructed from a range of materials which are known to be suitable for valve connections including a variety of metals and hard plastics including glass filled Nylon.

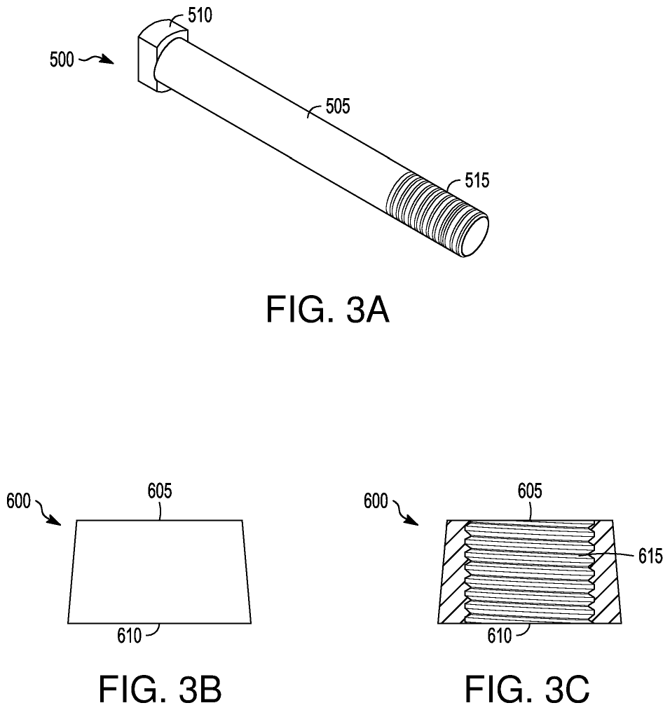

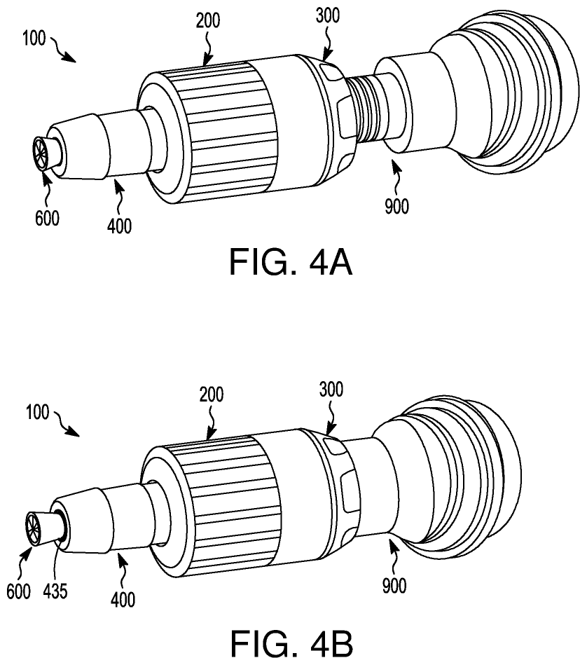

FIG. 3A shows a pin 500 which comprises an elongate body 505, a generally T-shaped pin head 510 and an engaging portion 515 which in the embodiment shown is a pin threaded section 515. The pin 500 may be constructed from glass filled nylon or other materials considered suitable for valve core spigots. Preferably, the pin 500 is made from a polymer including a glass-filled polymer. From FIG. 1C it can be seen that the pin head 510 and the upper extent of the pin elongate body 505 adjacent the pin head 510 are generally located within the connector cavity 330. An underside of the pin head 510 abuts onto the biasing member 700, which in the embodiment shown is a spring 700. The spring 700, at its opposite end also abuts onto the biasing surface 420 to form a biasing mechanism whereby downward pressure on the pin head 510 will compress the spring 700 and, once the pressure is removed, the spring 700 will extend to its original shape thereby raising the pin 500.

The majority of the pin elongate body 505 is located within the channel 435 but the lower extent, at an end opposite to that of the pin head 510, being the pin threaded section 515 at least partly extends through the channel open second end 430 to engage with the bung 600, which in the embodiments shown is a tapered bung 600. The tapered bung 600 is seen, in FIGS. 3B and 3C, to be of a simple tapered or wedge shape with an engages with the pin threaded section 515 of the pin 500. It will be appreciated open constricted end 605 and an open wide end 610. The hollow interior is provided with a bung threaded portion 615 which screw-threadedly or, optionally, compression fits such that when the tapered bung 600 abuts against or into the channel second open end 430 then the channel 435 will be sealed at its lower extent. If, however, the tapered bung 600 is distanced from the channel second open end 430 then the channel 435 will be open to fluid flow.

In use, the outlet coupling 100 can be screwed onto a tire valve stem 900, as represented in FIGS. 4A and 4B. With reference to these figures and FIG. 1C it will be understood that the housing threaded portion 220 can be screwed onto the tire valve stem 900, following removal of any protective cap (not shown) which will bring the valve spigot of the valve core of the tire valve stem 900 into alignment with the pin head 510. FIG. 4A represents a point where the valve spigot of the tire valve stem 900 has not yet made contact with the pin head 510 and so the tapered bung 600 is still in an engaged position with the channel 435 which is therefore sealed to fluid flow. In FIG. 4B, however, the tire valve stem 900 is further screwed into the housing cavity 225 such that the valve spigot has contacted and depressed the pin head 510. This in turn forces the pin 500 in a direction along an axis passing through the channel 435 such that the tapered bung 600 becomes spaced from the channel second open end 430 and therefore allows for fluid flow around the tapered bung 600 and into the channel 435. This represents an open position. Once a sufficient amount of the sealant fluid has been dispensed then the outer housing 200 can be unscrewed from the tire valve stem 900 and the spring 700 will force the pin head 510 back towards the housing open first end 210 until the tapered bung 600 again becomes wedged within the channel 435 in the fully biased or engaged position. This represents a closed position.

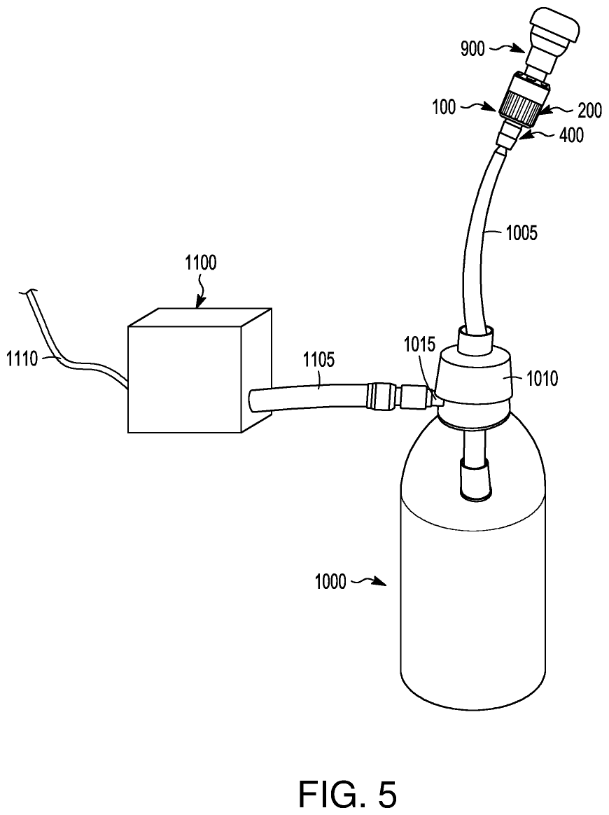

FIG. 5 shows the outlet coupling 100 in use with a sealant container 1000 which would contain an appropriate sealant formulation such as that described in the applicant's PCT application WO 2017/075673, which is hereby incorporated by reference in its entirety. The channel piece 400 has been forced into an outlet hose 1005 which will typically be constructed from a nylon, PVC or similar flexible, plastic. The outer ribs 405 deform the outlet hose 1005 around them and prevent it from slipping off. Any sealant container 1000 may be appropriate for use with the outlet coupling as all that is required is an outlet hose 1005 for engagement. Nonetheless, it is particularly preferred to use a container and kit such as that described in the present applicant's earlier international application number PCT/AU2017/050126, or in the present applicant's earlier Australian patent application number AU2016905062, which are both hereby incorporated by reference in their entirety.

In the embodiment shown in FIG. 5, the sealant container 1000 is provided with a lid 1010, through which the outlet hose 1005 passes, and a neck inlet 1015 through which compressed air can be provided to provide a pressure increase to force the sealant formulation out of the outlet hose 1005. A compressor 1100 drives the pressure increase into the sealant container 1000 through a compressor connector 1105 and is powered through a power lead 1110 which may lead to a power connection to connect with a standard car power socket, such as a cigarette lighter socket. In FIG. 5, the tire valve stem has been connected to the outlet coupling 100 and the channel piece is within the outlet hose 1005, so activating the compressor will result in sealant formulation being forced from the sealant container 1000, through the outlet hose 1005, through the channel 435 and connector cavity 330 to then pass through the tire valve core and into the tire to seal the puncture.

The further broad form addresses a pressure release system for a sealant container. The pressure release system may be employed with any sealant container but it is preferred that it is used with that PET-based container disclosed in the present applicant's earlier Australian patent application number AU2016905062 but with modifications as discussed below. This is because there are particular challenges associated with plastic sealant containers. The internal pressure generated by a compressor within such containers can be very significant and may well be too high for the strength of the container. This can result in an explosion with uncontrolled and rapid release of the sealant formulation. As the pressure generated may vary with the generating means, such as a compressor, it would be beneficial to have a pressure release system as a component of a kit-based, universal or after-market sealant container.

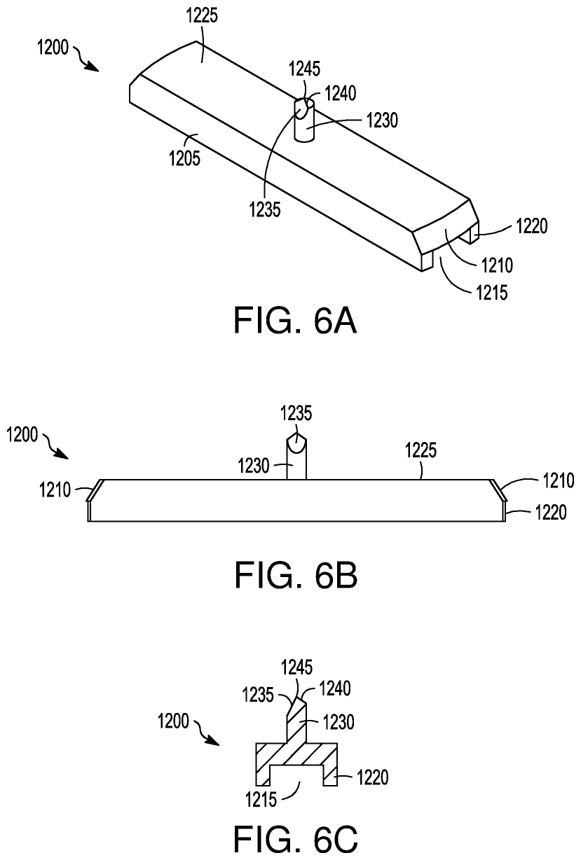

FIGS. 6A-C show a pressure release device 1200 forming part of the pressure release system. The pressure release device 1200, in the embodiment shown, comprises an elongate body 1205 which at each end, on an upper surface thereof, presents chamfered faces 1210. It should be appreciated that the pressure release device 1200 is not limited to this particular shape but rather it is designed to conform with that of the sealant container 1000 it is to be located within. The pressure release device 1200 could equally be circular to substantially conform to the bottom inner surface of the sealant container 1000 but the elongate bar-shape of FIG. 6A is both effective and efficient in design. The underside of the pressure release device 1200, as seen in FIGS. 6A and 6C, has a cut away or open section 1215 defined by walls 1220. The open section 1215 reduces the weight and materials expense of the pressure release device 1200. The chamfered faces 1210 are joined by a sealing face 1225 from which, in a generally central region, extends a sealing spigot 1230. The sealing spigot 1230 ends in a first inclined face 1235 and a second inclined face 1240 thereby also forming an apex 1245 at the upper extent of the sealing spigot 1230. The sealing spigot 1230 is tapered up to the apex 1245 to allow a gradual discharge, rather than a sudden release of sealant formulation when and if the spigot suddenly opened. This allows for a more controlled release of pressure.

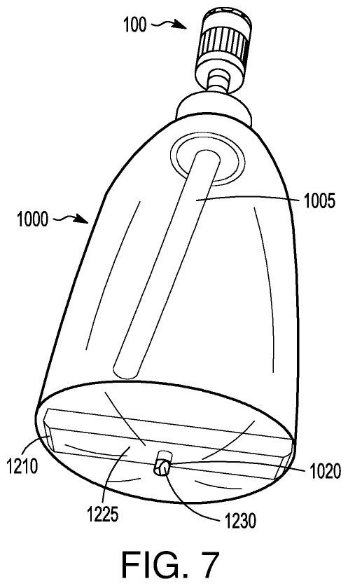

FIG. 7 shows the pressure release device 1200 in place within the sealant container 1000, which in this figure does not show the neck inlet and other detailed components of the sealant container 1000. The outlet coupling 100 and hose outlet 1005 are as previously discussed but, in this embodiment, the sealant container 1000 is provided with a container aperture 1020 which is formed in the base of the sealant container 1000. The sealing spigot 1230 is seen to pass through the container aperture 1020 and, in the embodiment shown, forms a simple interference fit therein. It can also be seen that the chamfered faces 1210 of the pressure release device 1200 allow for it to be snugly wedged against the walls of the sealant container 1000. The particular engagement of the chamfered faces 1210 with the sealant container 1000 will clearly depend on the shape and internal features of the sealant container 1000 but, in preferred embodiments, they are conveniently wedged under small formations or dimples (not shown in the figures) formed in the walls of the sealant container 1000 or, alternatively, wedged against any inward curvature of the walls. The pressure release device 1200 is thereby securely locked in place to prevent being dislocated due to any sudden inertia.

In use, the internal pressure generated within a plastic sealant container 1000 will, when excessive, most notably cause the generally convex base to be distorted and forced away from the sealing face 1225 of the pressure release device 1200. As the pressure release device 1200 itself is held in place by its engagement with the convex dimples in the walls of the sealant container 1000 or the curvature of those walls, the result is that the container base, and so the container aperture 1020, are caused to move along the sealing spigot 1230 away from the sealing face 1225 and towards the apex 1245. Once the container aperture 1020 passes the initial sloping portion of the first inclined face 1235 this creates an opening which allows sealant formulation and air to pass through, thereby reducing the pressure within the sealant container 1000. The closer the container aperture 1020 gets to the apex 1245 then the greater becomes the opening, with the second inclined face 1240 becoming involved. Under more extreme pressures the base may even extend beyond the apex 1245 such that the entire container aperture 1020 is unobstructed, allowing the maximum pressure release. While this system will allow sealant formulation to stream out of the container aperture 1020, at pressure, this is nonetheless a safer outcome than risking the entire sealant container exploding.

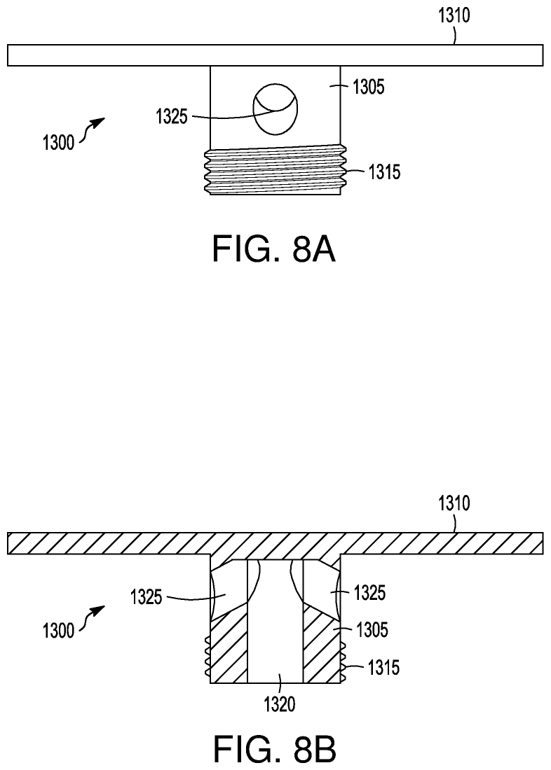

An additional safety component of the pressure release system is incorporated and shown in FIGS. 8A and 8B as a deflection baffle 1300. The deflection baffle 1300 comprises a generally circular (in cross section) body 1305 and a baffle head 1310. At the end of the body 1305 opposite to that intersecting the baffle head 1310 is a baffle threaded portion 1315. A central channel 1320 is formed within the body 1305 and opens at its lower extent. The central channel 1320 is intersected by additional channels 1325 which in the embodiments shown are two angled channels 1325 which may sit at an angle of approximately 60 degrees to the central channel 1320.

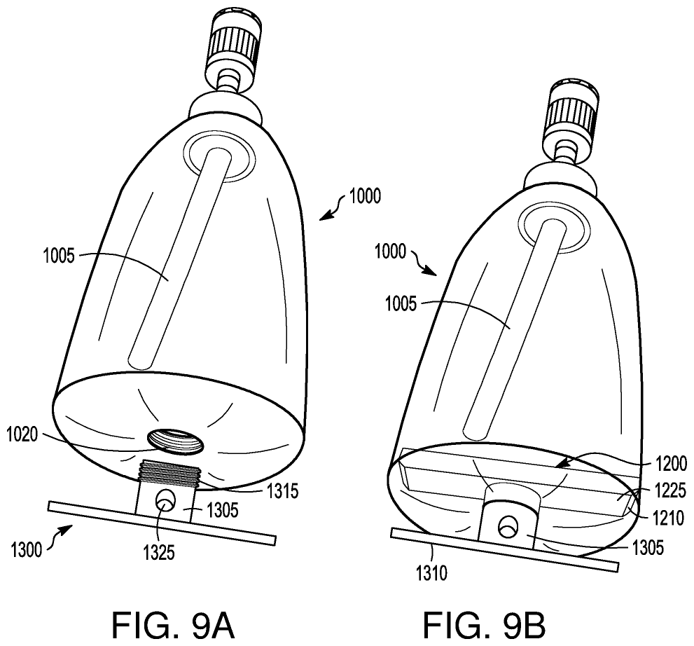

FIGS. 9A and 9B show the manner of engagement of the deflection baffle 1300 with the sealant container 1000 and with the pressure release system, respectively. In FIG. 9A it can be seen that, in this embodiment, the container aperture 1020 is threaded such that it can receive and engage with the baffle threaded portion 1315 of the baffle body 1305. This results in the deflection baffle 1300 being affixed to the exterior of the base of the sealant container 1000 with the central channel 1320 open to the interior of the sealant container 1000 and the ends of the angled channels 1325 which open through the body 1305 being external to the sealant container 1000.

FIG. 9B shows the deflection baffle 1300 fixed in place, as described, and the pressure release device 1200 also lodged in place as described for FIG. 7. The engagement of the deflection baffle 1300 in the container aperture 1020 means that when the sealing spigot 1230 of the pressure release device 1200 passes through the container aperture 1020, it is accommodated within the central channel 1320 of the deflection baffle 1300 and thereby provides a sealing engagement which prevents the passage of sealant formulation. When the internal pressure within the sealant container increases such that the base is deformed outwards, as described above for FIG. 7, then the deflection baffle 1300 also moves along the sealing spigot 1230 until, again, an opening is formed for the escape of pressurised sealant formulation. The difference provided for in the embodiment of FIG. 9B is the fluid path control effect provided for by the deflection baffle 1300. The pressurised sealant will pass along the central channel 1320 and then be directed into the angled channels 1325. Due to the particular angle of the angled channels 1325, the sealant will be harmlessly directed back into the exterior of the container base. The introduction of a deflection baffle 1300 therefore provides significant benefits in the safe usage of the pressure release system.

It will be appreciated that the shape of the baffle head 1310 is not of particular importance and the body 1305 simply has to have a region which can engage within the container aperture 1020. While the embodiment shown has a screw-threaded engagement, it will be appreciated that many other connections can be envisaged. Further, while two additional or angled channels 1325 provide for an effective controlled pressure release, it should be understood that a single such additional channel formed at any angle which either directs the pressurised sealant onto the exterior of the container base or onto the deflection baffle head 1310 may also be appropriate.

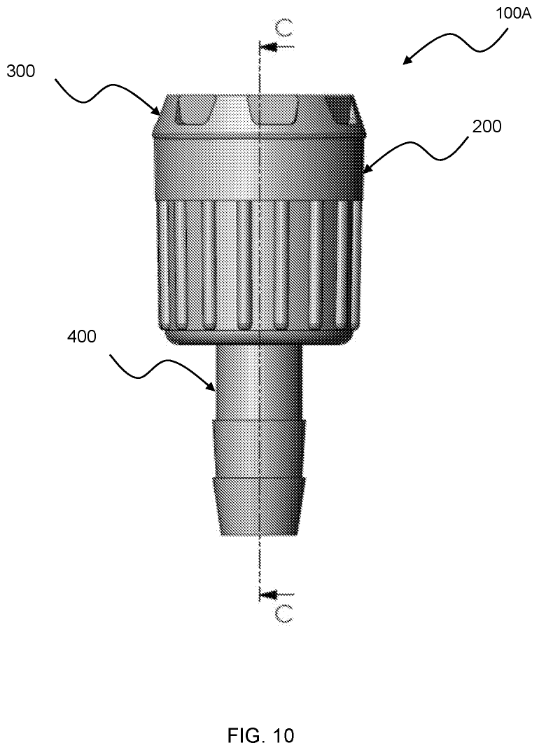

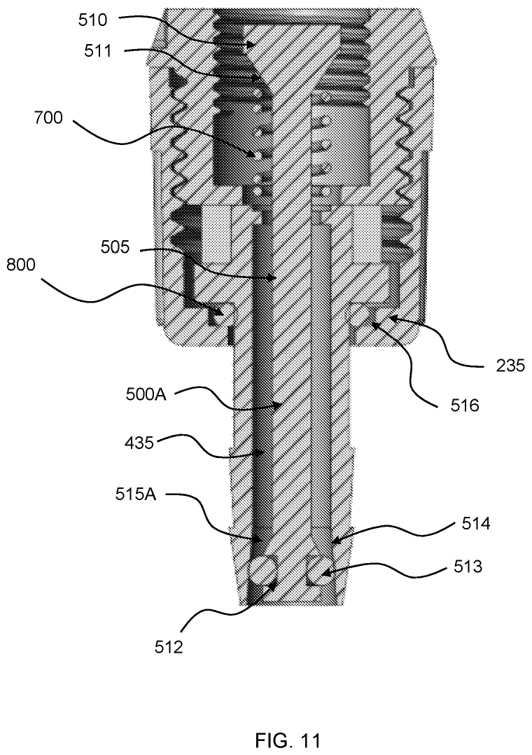

FIGS. 10-12 show another embodiment of the outlet coupling in the form of outlet coupling 100A. As with the previous embodiment described herein, outlet coupling 100A comprises an outer housing 200, a connector 300, a channel piece 400, a pin 500A, a biasing member 700 and a sealing member 800. In this embodiment, sealing member 800 is accommodated within a recess 516 in housing flange 235. In this embodiment, pin 500A comprises a pin head 510 having tapered sides 511 at the upper extent of the elongate body 505 of the pin extending from. An engaging portion 515A at a lower extent of the elongate body 505 comprises an enlarged region, or region of larger diameter compared with the elongate body 505 of the pin. The enlarged region comprises an annular recess 512 for engagingly receiving a sealing element 513. In this embodiment, the sealing element 513 is in the form of an O-ring, rather than in the form of the tapered bung 600 of the previous embodiment. At a lower extent of the channel 435 of the channel piece 400, an inner wall 514 is tapered or flared outward such that in a closed position, sealing element 513 abuts the inner wall 514 of the channel 435, thus sealing the channel 435 to fluid flow. With particular reference to FIG. 13, when the tire valve stem 900 is screwed sufficiently into the housing cavity 225 of the outer housing 200, pin 500A moves along the axis of the channel 435 of the channel piece 400 such that sealing element 513 is spaced from the end of the channel 435 thus allowing fluid flow into the channel 435.

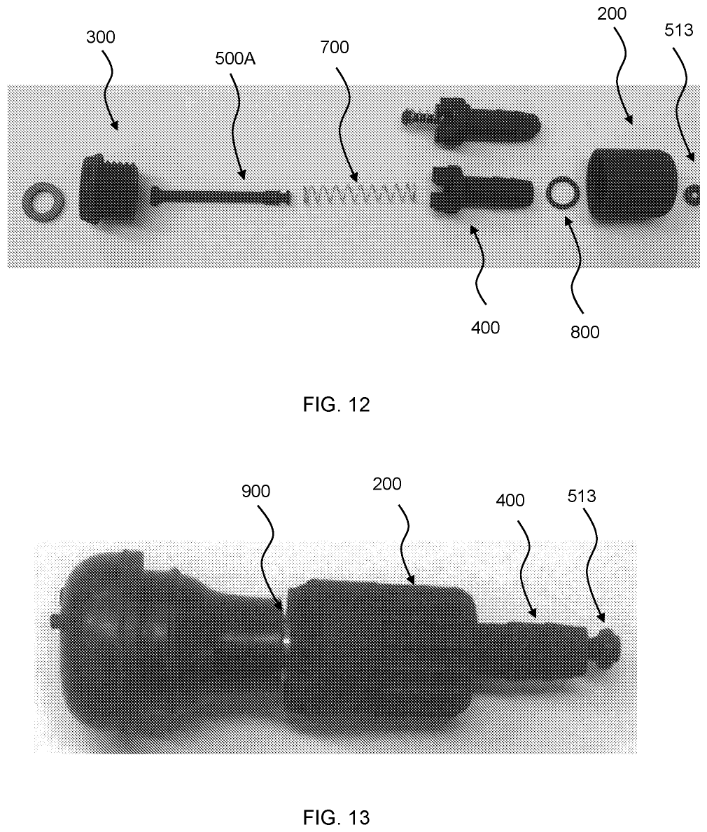

In the exploded view shown in FIG. 12, a second channel piece 400 is also shown with the pin 500A, biasing member 700, sealing member 800 and sealing element 513 assembled together and ready for insertion into the outer housing 200 to which connector 300 is coupled.

The outlet couplings of the present invention, and in particular the outlet coupling according to the embodiment shown in FIGS. 10-13, are simpler than at least some of the known outlet couplings and have fewer parts. Consequently, the outlet couplings of the present invention are robust, cheaper to manufacture, easier and quicker to assemble.

Further to all of the foregoing, the methods of the invention may further comprise the step of inverting the sealant container 1000 prior to providing the pressure within. The pressure may be pressurised air and, as discussed, this may be supplied by a compressor or the like.

The methods of the invention may be performed using the components as described in any one or more embodiments of the first or second broad forms.

In one embodiment, the pneumatic tire is a tire of a car, van, truck or bicycle. The present apparatus will find common use in the repair of car tires.

The above description of various embodiments of the present invention is provided for purposes of description to one of ordinary skill in the related art. It is not intended to be exhaustive or to limit the invention to a single disclosed embodiment. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

In the claims which follow and in the preceding description of the invention, except where the context clearly requires otherwise due to express language or necessary implication, the word “comprise”, or variations thereof including “comprises” or “comprising”, is used in an inclusive sense, that is, to specify the presence of the stated integers but without precluding the presence or addition of further integers in one or more embodiments of the invention.

1. An outlet coupling for a sealant container comprising:
(a) a connector having an open first end, to engage with a tire valve stem, and an open second end continuous with a channel;
(b) a pin at least partially located within the channel, the pin comprising a body having a head and an engaging portion at substantially opposite ends thereof, the head in contact with a biasing member and the engaging portion engaged with a sealing element; and
wherein, the pin is movable between an open position wherein the sealing element is spaced from an end of the channel and a closed position wherein the sealing element seals the end of the channel.

2. The outlet coupling of claim 1 wherein the connector comprises a cavity located between the open first and second ends and continuous with both.

3. The outlet coupling of claim 2 wherein an inner surface of the cavity is adapted to engage with the tire valve stem, in particular a tire valve core spigot.

4. The outlet coupling of claim 3, wherein the inner surface of the cavity comprises one of the following to engage with the tire valve stem: a screw thread; an interference fit arrangement; a click-on mechanism; a snap lock mechanism; a bayonet fitting.

5. The outlet coupling of claim 3 wherein the pin head extends beyond the inner surface of the cavity adapted to engage with the tire valve stem.

6. The outlet coupling of claim 1, wherein the biasing member is a spring which contacts an underside of the pin head or tapered sides extending from the pin head.

7. The outlet coupling of claim 1, further comprising a channel piece which defines the channel within its interior.

8. The outlet coupling of claim 7 wherein an upper extent of the channel piece defines a biasing surface contacted by the biasing member wherein the biasing surface of the channel piece is adjacent an underside of the connector.

9. The outlet coupling of claim 7, wherein the sealing element is i) a bung which abuts an end of the channel piece substantially opposite to the end of the outlet coupling having the connector open first end or ii) an O-ring engagingly received at least partially within an annular recess in the engaging portion of the pin.

10. The outlet coupling of claim 9 wherein the engaging portion of the pin extends beyond an end of the channel piece to be at least partially accommodated within the bung, by a screw-threaded or press fit connection.

11-12. (canceled)

13. The outlet coupling of claim 8, wherein a lower extent of the channel comprises an outwardly flared inner wall such that in the closed position the O-ring abuts the inner wall thus sealing the channel to fluid flow.

14. The outlet coupling of claim 1, further comprising an outer housing within which the connector is at least partially located and fastened within the outer housing with one of the following: a screw-thread; an interference fit a male-female connection.

15-16. (canceled)

17. The outlet coupling of claim 1, wherein an outer surface of the channel piece has one of more of the following gripping features which improve the grip of a sealant hose onto the outer surface: a hose barb fitting; scoring; a roughened surface; one or more ribs or lips.

18. (canceled)

19. The outlet coupling of claim 14, wherein the outer housing has: i) a housing cavity within which an upper extent of the channel piece is located; and/or ii) comprises an opening through which the channel piece passes.

20. (canceled)

21. The outlet coupling of claim 20 wherein the channel piece forms a sealing engagement with the opening of the outer housing through which it passes, wherein the sealing engagement is assisted by an O-ring or like sealing or fastening member, wherein the O-ring or like sealing or fastening member is optionally accommodated within a recess in a housing flange of the outer housing.

22-24. (canceled)

25. The outlet coupling of claim 1, wherein all components of the outlet coupling are made from one or more of a polymer, a plastic or a composite material, in particular a glass-filled polymer such as a glass-filled nylon.

26. A method of sealing a puncture in a pneumatic tire including the steps of:
(a) providing a tire repair apparatus comprising a sealant container containing a sealant formulation, the sealant container having an outlet hose extending therefrom and the outlet hose provided with an outlet coupling, wherein the outlet coupling comprises;
i. a connector having an open first end, to engage with a tire valve stem, and an open second end continuous with a channel;
ii. a pin at least partially located within the channel, the pin comprising a body having a head and an engaging portion at substantially opposite ends thereof, the head in contact with a biasing member and the engaging portion engaged with a sealing element;
iii. wherein, the pin is movable between an open position wherein the sealing element is spaced from an end of the channel and a closed position wherein the sealing element seals the end of the channel;
(b) connecting the open first end of the connector to a valve stem of the pneumatic tire such that the pin engages with a valve core spigot of the valve stem to force the pin into the open position; and
(c) providing a fluid pressure within the container;
to thereby discharge the sealant formulation from the sealant container into an internal chamber of the pneumatic tire and seal the puncture.

27. (canceled)

28. A pressure release system for a sealant container comprising:
(a) a sealant container comprising a base having an aperture formed therethrough; and
(b) a pressure release device comprising a sealing face having a sealing spigot extending therefrom;
wherein, the sealing spigot of the pressure release device is located within the aperture.

29. The pressure release system of claim 28 wherein the sealing spigot of the pressure release device forms a sealing engagement within the aperture.

30. The pressure release system of claim 28 wherein the pressure release system further comprises a deflection baffle which engages with the aperture.

31. The pressure release system of claim 30 wherein the deflection baffle engages with the aperture and the sealing spigot of the pressure release device is accommodated within the deflection baffle.

32. The pressure release system of claim 31 wherein the deflection baffle has at least one channel within which the sealing spigot of the pressure release device is at least partly accommodated.

33. The pressure release system of claim 32 wherein the at least one channel is a central channel which is intersected by at least one additional channel.

34. The pressure release system of claim 28, wherein the pressure release device comprises one or more of the following: an elongate body; at least one chamfered face to engage with the sealant container.

35. (canceled)

36. A method of sealing a puncture in a pneumatic tire including the steps of:
(a) providing a tire repair apparatus comprising a sealant container containing a sealant formulation, the sealant container comprising;
i. an outlet hose extending therefrom;
ii. a base having an aperture formed therethrough;
iii. a pressure release device located within the sealant container and comprising a sealing face having a sealing spigot extending therefrom, the sealing spigot located within the aperture;
(b) connecting the outlet hose to a valve stem of the pneumatic tire; and
(c) providing a fluid pressure within the sealant container;
to thereby discharge the sealant formulation from the sealant container into an internal chamber of the pneumatic tire and seal the puncture.
